(19) United States
(12) Patent Application Publication
(10) Pub. No.: US 2006/0196579 A1
(43) Pub. Date: Sep. 7, 2006

(54) High energy soldering composition and method of soldering

(76) Inventors: Andrew F. Skipor, West Chicago, IL (US); Krishna D. Jonnalagadda, Algonquin, IL (US); Steven M. Scheifers, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/073,919

(22) Filed: Mar. 7, 2005

(51) Int. Cl. B23K 35/34

(52) U.S. Cl. 148/24

(57) ABSTRACT

A low temperature, high energy soldering composition for joining metals together contains a fluxing agent and high energy metal particles that possess sufficiently high internal energy, suspended in the fluxing agent, such that the melting point of the high energy metal particles is depressed by at least three degrees Celsius below the normal bulk melting temperature of metal. A solder joint is effected by placing the high energy metal particles in contact with one or more of the metal surfaces and heating the high energy metal particles in the presence of a fluxing agent to melt the high energy metal particles and fuse them to the metal surface.

### FIELD OF THE INVENTION

This invention relates generally to melting point depression of small metal particles. More particularly, this invention relates to a soldering composition having high-energy metal particles that have a depressed melting point.

### BACKGROUND

The phenomena of melting point depression of nanoscale metal particles has been studied since the 1950's, when it was noticed that these extremely small particles of metal have a lower melting point than the bulk material. This results from the increasingly important role of the surface as the size of the nanostructures decreases. As the size decreases, an increased proportion of atoms occupy the surface or interfacial sites as opposed to the interior. These interfacial atoms possess higher energy than bulk atoms, which facilitates the melting of the nanoparticle. However, this mechanism is not fully understood to this day. Initially, x-ray diffraction (XRD) was used to determine if these very small solid particles changed from ordered to a disordered phase, later followed by transmission electron microscopy (TEM) to monitor the loss of crystalline structure. More recently, alternate experimental methods such as calorimetry measured the heat capacity and latent heat of fusion as a function of the temperature. A new calorimetric technique known as nano-calorimetry has been developed where nano-Joules of heat are measured. A simple expression was developed in 2002 by Dr. Leslie Allen at the University of Illinois that relates melting point to particle size:
Tₘ(r)=156.6-(220/r)
where Tₘ(r) is the melting temperature in degrees Centigrade and r is the radius of the particle in nanometers. Inspection of this equation reveals that significant melting point suppression happens only when the particle radius approaches the 5 to 10 nanometer range, and no appreciable melting point suppression occurs when particle sizes exceed 50 nanometers in diameter. Further, all prior studies have focused on pure metals, not mixtures of metals or alloys. A need exists to depress the melting point of metal and metal alloy particles in the size range greater than the 1-50 nanometer range studied to date.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a bar chart depicting particle size distribution of iron particles consistent with certain embodiments of the present invention.

FIG. 2 is a differential scanning calorimetry graph of high-energy particles of tin consistent with certain embodiments of the present invention.

FIG. 3 is a schematic representation of bulk particles mixed with small sized high-energy particles consistent with certain embodiments of the present invention.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and is not intended to limit the invention to the specific embodiments shown and described. In the description below, like reference numerals are used to describe the same, similar or corresponding elements in the several views of the drawings. A low temperature, high energy soldering composition for joining metals together contains a fluxing agent and high energy metal particles suspended in the fluxing agent, such that the melting point of the high energy metal particles is depressed by at least three degrees Celsius below the normal bulk melting temperature of metal. A solder joint is effected by placing the high energy metal particles in contact with one or more of the metal surfaces and heating the high energy metal particles in the presence of a fluxing agent to melt the high energy metal particles and fuse them to the metal surface.

The melting point of a solid has been classically defined as that temperature at which the vapor pressure of the solid is the same as the vapor pressure of the liquid formed when the material melts. The relationship between melting point and particle size has previously been studied by a number of researchers using nanoscale particles of tin, gold, and indium. All of these studies focused on materials with diameters less than 50 nanometers produced by evaporation in a vacuum, and most literature indicates that the melting point ceases to be significantly altered when particle size exceeds this level. While we are interested in this size range, we address here the generally larger size ranges in order to make the application of this phenomena more practical. It should be noted that these larger particles are not produced by conventional methods used to make solder used in solder pastes. Our work shows that melting point suppression is exhibited in solids greater than 50 nanometer diameter that possess energies higher than the thermodynamically most stable bulk phase(s) for a metal or metal alloy. We define ‘high energy particles’ as those particles having a vapor pressure greater than that of the thermodynamically lowest energy bulk phase, or multiplicity of phases, at equal temperatures and pressures. ‘Bulk’ is understood to mean a substantially sufficient quantity of material that resides as a single bound entity such that the material can assume the lowest achievable thermodynamic state without regard to specific external influences (e.g. placed in tension or compression or other mechanical working) or inducement (e.g. held in an electric or magnetic field), but providing no further requirements to preserve the lowest thermodynamically attained state.

There are two ways to make these higher energy solids. One way is to produce them in a manner that causes the solid to form in a higher energy state by manipulating the kinetics of the formation process. These solids form in metastable energy states which annealing or melting may cause to relax to the thermodynamically preferred energy state. The other way is to force the solid, by virtue of its environment, to assume a thermodynamically stable structure that is different from the bulk structure. Annealing and melting of the solid does not necessarily form the thermodynamically preferred energy due to the disposition of the solid. We have identified four methods to produce high-energy solid metal and metal alloys:
1) High energy vaporization of bulk metals (thin wires or films for example), followed by very rapid quenching to form metastable solids.
2) Spraying high-speed molten jets of metal (flame spray, for example) followed by rapid quenching to form metastable solids.
3) Chemical reduction of nano-scale metal oxides to form thermodynamically stable solid metal.
4) Patterning thin films on substrates by plating or deposition, typically metallic, that give rise to at least one thermodynamically stable but higher energy solid, which is usually the deposited material(s).

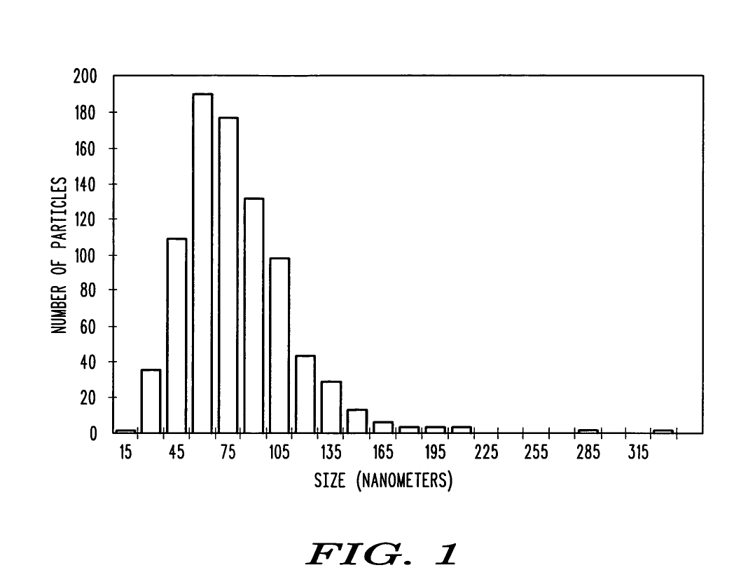

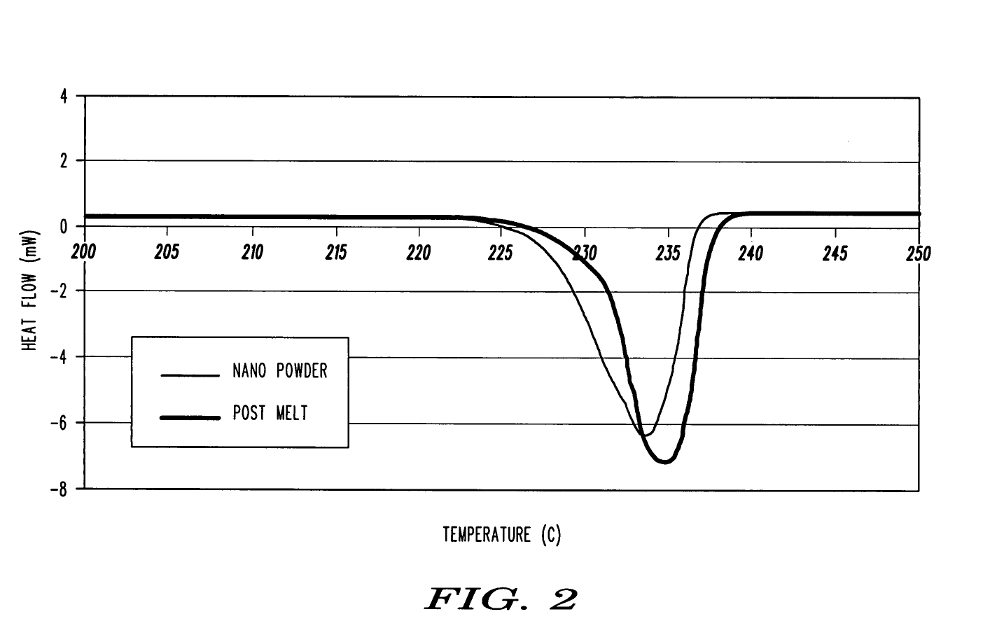

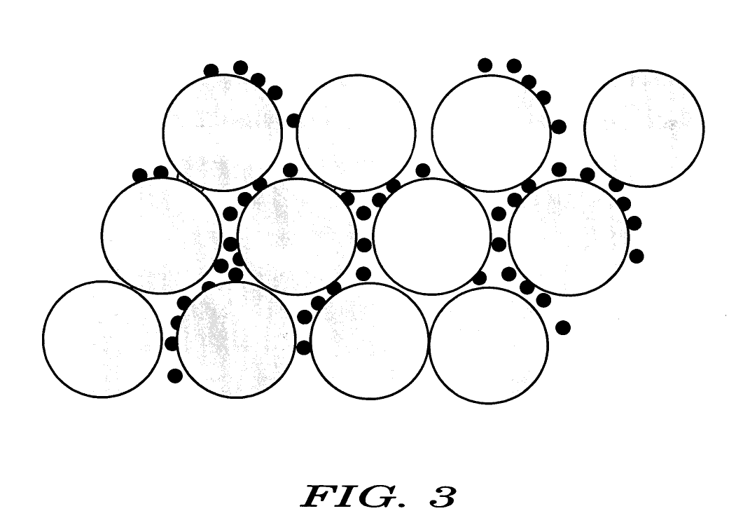

Traditional methods to produce metal and metal alloy spheres for solder paste typically are: 1) dispersion of molten solder alloy by impacting a stream of the molten metal with a jet of gas that disperses the molten stream into tiny droplets; 2) milling of bulk metals; and 3) melt dispersions in hot oil to make particles. None of these processes produce high-energy metal particles. Published literature indicates that the nanoscale melting point is generally only sensitive to particle sizes less than 10 nanometers in diameter, with dramatic lowering seen at less than 5 nanometers. In contrast, FIG. 1 shows the particle size distribution curve of a sample of iron comprised of high energy particles ranging from 15 to over 300 nanometers, that has only a very small amount of particles that are 15 nanometers or less in size. We have measured samples having an average particle size that is larger than that of FIG. 3 and found that melting points (as measured by differential scanning calorimetry) are depressed by 3-5 degrees Celsius. For example, one sample of a “nano-tin” material depicted in FIG. 2 that is comprised of high energy particles has only a small fraction of particles below 20 nm, yet has a melting point that is 5 degrees C. less than what was demonstrated by the bulk material. This suggests that a highly disordered particle, i.e., a more energetic particle, accounts for the temperature depression even for a particle that is approaching a ‘bulk’ scale. A 20 nm particle of tin has approximately 360,000 atoms, approaching ‘bulk’ when compared to 5 or 10 nanometer particles. The melting point depression of other tin high energy particle samples and other high energy metal particles could be even more significant, as much as 10 -50 degrees or more.

These principles can be used for both pure metals and alloys of metals to form interconnect materials that may be used to form electrical interconnects in electronics products. For example, a low temperature solder interconnect material can be created by using combinations of higher energy metals, metal alloys or bulk materials, as shown, for example, in FIG. 3. Some examples of these hybrid interconnect materials are:
1. 100% of one or more high-energy metals.
2. 100% of one or more high energy metal alloys.
3. A binary mixture of high-energy metal and high-energy metal alloy
4. A binary mixture of bulk metal and high energy metal.
5. A binary mixture of bulk metal and high-energy metal alloy.
6. A binary mixture of bulk metal alloy and high energy metal.
7. A binary mixture of bulk metal alloy and high-energy metal alloy.
8. A tertiary mixture of bulk metal, bulk metal alloy, and high energy metal.
9. A tertiary mixture of bulk metal, bulk metal alloy, and high-energy metal alloy.
10. A four component mixture of bulk metal, bulk metal alloy, high energy metal, and high energy metal alloy

There are, of course, other combinations of these four types of materials that will occur to the reader, and the examples listed above are presented by way of illustration and not by way of limitation. In order to form a high energy soldering composition to solder electronic components together, the high energy particles are suspended in a matrix of a conventional fluxing agent. The high energy soldering composition is then placed in contact with one or more metal surfaces, for example, an electronic component on a printed circuit board, and the metal surfaces and the high energy soldering composition are heated to melt the high energy metal particles and fuse them to the metal surface. The fluxing agent, removes any oxides on the metal surfaces and/or the high energy metal particles to facilitate soldering. The fluxing agent can also serve as an oxygen barrier to prevent re-oxidation of the metal surfaces and the particles. Since the high energy metal particles melt at a temperature that is lower than the normal melting temperature of the ‘bulk’ metal or metal alloy, soldering can be effected at a temperature that is substantially less than would normally be expected. Metals that can be used to form the high energy particles are aluminum, antimony, beryllium, boron, bismuth, cadmium, chrome, cobalt, copper, gold, indium, iron, lead, lithium, magnesium, manganese, nickel, phosphorous, platinum, silver, tin, titanium, and zinc. Alloys of two or more of these metals can also be used, singly, or in combination with the metal or with additional metal alloys. High energy particles need not be 10 nm or less nor does this preclude them from being substantially comprised of particles less than or equal to 10 nm. It is to be understood that while the process for forming the particles may produce particles that approximate spheres, they need not necessarily be perfectly spherical in shape, but can be other shapes. Additionally, the high energy particles should be of the size, shape, and energy state such that the melting point of the particles is at least 3 degrees Celsius less than the melting point of a comparable composition of ‘bulk’ material.

Another embodiment of the invention finds particles of ‘bulk’ metal or metal alloys mixed with the high energy particles, and suspended in the fluxing agent matrix. Referring now to FIG. 3, large particles of bulk material are mixed with much smaller sized high energy particles to form a binary mixture, as in examples 4-6 above. Both the bulk material and the high energy particles are chemically the same composition, in contrast to prior art that uses particles of different metals or alloys in a mixture. Even though the two different sized particles are the same chemically, the small particle have a higher energy than the bulk material, and thus, depresses the melting point of the mixture. The use of high energy particles that have a depressed melting point facilitates the substitution of a number of metals in place of the lead that has been used in solder for many decades. The elimination of lead in solder has been sought after by many, as lead is viewed as an environmental and health hazard, but has yielded few viable candidates, as most metals, alloys, and combinations thereof have melting points that are in excess of combinations that use lead. The lowered melting points demonstrated by high energy metal particles now enables one to craft a lead-free soldering composition that has a melting point low enough to be usable in the electronics industry.

In summary, without intending to limit the scope of the invention, the use of high energy solid metal and metal alloy particles is a novel way to create a soldering composition that will reduce the reflow temperature of solder interconnects by depressing the melting point. Reduced temperatures facilitate the use of existing manufacturing lines and electronic components, minimizing the cost impact of transition to a no-lead solder, and one does not need to substitute electronic components that can withstand higher temperatures and/or retrofit manufacturing lines with higher operating temperature ovens.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A low temperature, high energy soldering composition for joining metals together, comprising:
a matrix comprising a fluxing agent;
high energy metal particles suspended in the matrix, comprising one or more metals selected from the group consisting of aluminum, antimony, beryllium, boron, bismuth, cadmium, chrome, cobalt, copper, gold, indium, iron, lead, lithium, magnesium, manganese, nickel, phosphorous, platinum, silver tin, titanium, and zinc; and
wherein the high energy metal particles are sufficiently energetic to depress the melting point of the high energy metal particles at least three degrees Celsius below the normal bulk melting temperature of the one or more metals.

2. The soldering composition as described in claim 1, wherein the high energy metal particles have a vapor pressure greater than that of a thermodynamically lowest energy bulk phase of the metal at equivalent temperature and pressure.

3. The soldering composition as described in claim 1, wherein the high energy metal particles comprise high energy metal particles greater than 10 nanometers in effective diameter.

4. The soldering composition as described in claim 1, wherein the high energy metal particles comprise nanoparticles less than 10 nanometers in effective diameter.

5. The soldering composition as described in claim 1, wherein the one or more metals comprises an alloy of two or more metals.

6. The soldering composition as described in claim 5, wherein the alloy is a soldering alloy.

7. The soldering composition as described in claim 1, wherein the high energy metal particles are formed by chemical reduction of nano-scale metal oxides to form thermodynamically stable solid metal.

8. The soldering composition as described in claim 1, wherein the high energy metal particles are formed by spraying molten metal at high speed followed by rapid quenching to form metastable solids.

9. The soldering composition as described in claim 1, wherein the high energy metal particles are formed by depositing a thin film on a substrate to form at least one high energy solid.

10. The soldering composition as described in claim 1, wherein the high energy metal particles are formed by vaporization of bulk metal followed by rapid quenching to form a metastable solid.

11. A low temperature, high energy soldering composition for joining metals together, comprising:
a matrix comprising a reducing agent;
nanoparticles suspended in the matrix, comprising one or more metals selected from the group consisting of aluminum, antimony, beryllium, boron, bismuth, cadmium, chrome, cobalt, copper, gold, indium, iron, lead, lithium, magnesium, manganese, nickel, phosphorous, platinum, silver tin, titanium, and zinc; and
wherein the nanoparticles are sufficiently energetic to depress the melting point of the nanoparticles at least three degrees Celsius below the normal bulk melting temperature of the one or more metals.

12. The soldering composition as described in claim 11, wherein the nanoparticles are less than 10 nanometers in effective diameter.

13. The soldering composition as described in claim 11, wherein the one or metals comprises an alloy.

14. The soldering composition as described in claim 13, wherein the alloy is a solder alloy.

15. The soldering composition as described in claim 11, wherein the high energy metal particles have a vapor pressure greater than that of a thermodynamically lowest energy bulk phase of the metal at equivalent temperature and pressure.

16. A method of forming a solder joint on a metal surface, comprising:
providing high energy metal particles comprising one or more metals selected from the group consisting of aluminum, antimony, beryllium, boron, bismuth, cadmium, chrome, cobalt, copper, gold, indium, iron, lead, lithium, magnesium, manganese, nickel, phosphorous, platinum, silver tin, titanium, and zinc, wherein the high energy metal particles are sufficiently energetic to depress the melting point of the high energy metal particles at least three degrees Celsius below the normal bulk melting temperature of the one or more metals; and
heating the high energy metal particles in the presence of a fluxing agent so as to melt the high energy metal particles and fuse them to the metal surface.

17. The soldering composition as described in claim 16, wherein the one or more metals comprises an alloy of two metals.

18. The soldering composition as described in claim 16, wherein the high energy metal particles have a vapor pressure greater than that of a thermodynamically lowest energy bulk phase of the metal at equivalent temperature and pressure.

19. The soldering composition as described in claim 16, wherein the high energy metal particles comprise high energy metal particles greater than 10 nanometers in effective diameter.

20. The soldering composition as described in claim 16, wherein the high energy metal particles comprise nanoparticles less than 10 nanometers in effective diameter.
